(19) United States
(12) Patent Application Publication
(10) Pub. No.: US 2013/0227967 A1
(43) Pub. Date: Sep. 5, 2013

(54) LNG VAPORIZATION EQUIPMENT

(71) Applicant: Yusuke Yamanaka, Tokyo (JP)

(72) Inventor: Yusuke Yamanaka, Tokyo (JP)

(21) Appl. No.: 13/882,821

(22) PCT Filed: Nov. 11, 2011
(86) PCT No.: PCT/JP2011/076104

§ 371 Date: May 1, 2013

(30) Foreign Application Priority Data
Nov. 12, 2010 (JP) 2010-254019

(51) Int. Cl. F17C 9/04

(52) U.S. Cl. CPC F17C 9/04
USPC 62/48.2

(57) ABSTRACT

An LNG vaporization equipment is provided with: a nitrogen supply apparatus (2); a heating apparatus (4) that heats nitrogen supplied from the nitrogen supply apparatus; vaporizers (6A, 6B, 6C) that vaporize LNG by means of a heat exchange between the nitrogen heated by the heating apparatus and the LNG that is fed out from an LNG tank (1); and a recirculation line (7) which, after the nitrogen after the heat exchange that has been discharged from the vaporizers has been used to reduce the amount of BOG that is generated or has been used for reliquefaction, recirculates it to the heating apparatus. By employing this structure, it is possible to provide the LNG vaporization equipment that is able to use the cooling energy of LNG to reduce the quantity of BOG that is generated, or for reliquefaction.

### TECHNICAL FIELD

The present invention relates to an LNG vaporization equipment.

Priority is claimed on Japanese Patent Application No. 2010-254019, filed Nov. 12, 2010, the contents of which are incorporated herein by reference.

### BACKGROUND ART

As is widely known, a group of facilities that receive, store, and vaporize LNG (Liquefied Natural Gas) is known as an LNG receiving terminal. In a conventional LNG receiving terminal, the LNG that is stored in an LNG tank is firstly fed to the outside of the tank by an in-tank type of send-out pump, and the pressure thereof is then raised to a desired pressure by a pot type of LNG booster pump. Finally, the LNG is vaporized by a vaporizer and is then delivered to a gas user such as a thermoelectric power station.

For example, in Patent document 1 (see below), an LNG vaporization system is disclosed in which, by reducing the amount of power used by the sea water pump, which is more than half of the energy consumed by the vaporizer, a decrease in the overall energy consumption is achieved.

### CITATION LIST

### Patent Documents

Patent document 1: Japanese Patent Application, First publication No. 2003-240194

### SUMMARY OF INVENTION

### Technical Problem

Conventional LNG receiving terminals are typically constructed on the seacoast in order to facilitate the task of receiving of LNG from LNG tankers. Because of this, as is described in the aforementioned Patent document 1, in a conventional LNG receiving terminal it is common for a particular type of vaporizer to be installed that vaporizes the LNG by utilizing an exchange of heat between sea water and the LNG. Because the flow rate of sea water that is discharged after the heat exchange from a vaporizer that utilizes sea water in this manner is adjusted such that the sea water has a higher temperature than the coagulation point of the LNG, it is difficult to use the sea water to reduce the quantity of BOG (Boil Off Gas) that is generated, or for reliquefaction.

The present invention was conceived in view of the above-described circumstances, and it is an object to provide an LNG vaporization equipment in which the cooling energy of LNG can be used to reduce the quantity of BOG that is generated, or can be used for reliquefaction.

### Solution to Problem

In order to solve the above-described problems, according to a first aspect of the present invention there is provided an LNG vaporization equipment that includes: a nitrogen supply apparatus; a heating apparatus that heats nitrogen supplied from the nitrogen supply apparatus; vaporizers that vaporize LNG by means of a heat exchange between the nitrogen heated by the heating apparatus and the LNG that is fed out from an LNG tank; and a recirculation line that, after the nitrogen that has been delivered from the vaporizers after the heat exchange has been used to reduce the amount of BOG that is generated or has been used for reliquefaction, recirculates it to the heating apparatus.

According to a second aspect of the present invention, in the above-described first aspect there is provided an LNG vaporization equipment in which, when the nitrogen after the heat exchange that is discharged from the vaporizers is used to reduce the amount of BOG that is generated, the recirculation line is installed as a dual system that is formed by a first recirculation line that connects the nitrogen discharge port of the vaporizers to the nitrogen intake port of the heating apparatus outside the LNG tank, and a second recirculation line that connects the nitrogen discharge port of the vaporizers to the nitrogen intake port of the heating apparatus via an inside of the LNG tank.

According to a third aspect of the present invention, in the above-described second aspect there is provided an LNG vaporization equipment that is equipped with a cutoff valve that, when the temperature of the nitrogen discharge port of the vaporizers is equal to or higher than the temperature of the BOG that is generated inside the LNG tank, blocks the inflow of nitrogen from the vaporizers to the second recirculation line.

According to a fourth aspect of the present invention, in the above-described first aspect there is provided an LNG vaporization equipment in which, when the nitrogen after the heat exchange that is discharged from the vaporizers is used reliquefy the BOG, the recirculation line is installed so as to connect the nitrogen discharge port of the vaporizers to the nitrogen intake port of the heating apparatus outside the LNG tank, and along the recirculation line there are provided: a first temperature adjuster that adjusts the temperature of the nitrogen flowing through the recirculation line to a temperature that enables the BOG generated within the LNG tank to be reliquefied; and a recondensor that reliquefies the BOG using a heat exchange between the temperature-adjusted nitrogen and the BOG that has been discharged from the LNG tank, and then restores the reliquefied BOG to an inside of the LNG tank.

According to a fifth aspect of the present invention, in the above-described fourth aspect there is provided an LNG vaporization equipment that is equipped with a nitrogen supply line that connects the nitrogen intake portion of the heating apparatus to the nitrogen intake port of the recondensor; a second temperature adjuster that is installed along the nitrogen supply line, and adjusts the temperature of the nitrogen flowing through the nitrogen supply line to a temperature that enables the BOG generated within the LNG tank to be reliquefied; and a first cutoff valve that blocks an inflow of nitrogen to the heating apparatus, and a second cutoff valve that blocks a reverse flow of nitrogen from the recondensor to the vaporizers such that, when the LNG is not being fed out from the LNG tank, nitrogen is supplied to the recondensor via the nitrogen supply line.

Note that, according to the above-described fourth or fifth aspects of the invention, while the operating pressure of the LNG tank is held at a constant level, the BOG discharged from the LNG tank undergoes a heat exchange with nitrogen that has already undergone a heat exchange and has been discharged from the vaporizers.

According to a sixth aspect of the present invention, in any one of the above-described first through fifth aspects, the heating apparatus, the vaporizers, and the recirculation line are installed on the roof of the LNG tank.

### Advantageous Effects of Invention

In an LNG vaporization equipment according to the present invention, LNG is vaporized via a heat exchange between nitrogen and LNG The temperature of the nitrogen after the heat exchange can be lowered to approximately the temperature of the LNG, and, in addition, by adjusting the pressure, can be lowered to below the temperature of the LNG. Namely, according to the present invention, if the nitrogen after the heat exchange with the LNG is used as a medium, the cooling energy of LNG can be used to reduce the quantity of BOG that is generated, or can be used for reliquefaction.

### BRIEF DESCRIPTION OF DRAWINGS

FIG. 1 is a view showing the schematic structure of an LNG vaporization equipment according to a first embodiment.

FIG. 2 is a view showing the schematic structure of an LNG vaporization equipment according to a second embodiment.

FIG. 3 is a view showing the schematic structure of an LNG vaporization equipment according to a third embodiment.

### DESCRIPTION OF EMBODIMENTS

Hereinafter, embodiments of the present invention will be described with reference made to the drawings.

### First embodiment

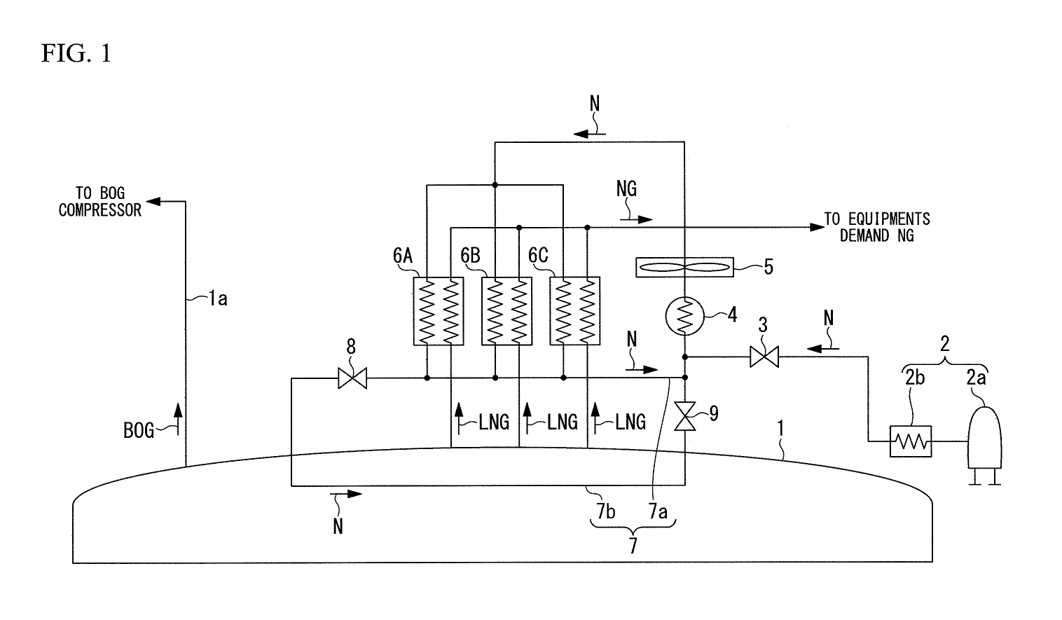

FIG. 1 is a view showing the schematic structure of an LNG vaporization equipment according to a first embodiment. As is shown in FIG. 1, the LNG vaporization equipment of the first embodiment is composed by an LNG tank 1, a nitrogen supply apparatus 2, a nitrogen flow rate adjuster valve 3, a heating apparatus 4, a blower 5, vaporizers 6A, 6B and 6C, a recirculation line 7, and cutoff valves 8 and 9.

Note that, in the aforementioned structural elements, at least the heating apparatus 4, the blower 5, the vaporizers 6A, 6B, and 6C, the recirculation line 7, and the cutoff valves 8 and 9 are mounted on the roof of the LNG tank 1.

The LNG tank 1 is a fixed type tank having a duplex shell structure that is used to store LNG Although omitted from the drawing shown in FIG. 1, a send-out pump that feeds stored LNG to the outside of the tank (i.e., to the vaporizers 6A, 6B, and 6C) is provided inside the LNG tank 1. Moreover, the symbol la is a BOG transfer line that discharges BOG (Boil Off Gas) that has been generated inside the LNG tank 1 to a BOG compressor (not shown).

The nitrogen supply apparatus 2 is formed by a liquid nitrogen tank 2a in which liquid nitrogen is stockpiled, and a vaporizer 2b that uses a heat exchange with air to vaporize liquid nitrogen that is delivered from the liquid nitrogen tank 2a. The vaporizer 2b delivers gaseous nitrogen (hereinafter, simply referred to as “nitrogen”) N that it has obtained from the heat exchange with the air to a nitrogen intake port in the heating apparatus 4 via the nitrogen flow rate adjuster valve 3.

The nitrogen flow rate adjuster valve 3 is an electromagnetic valve whose opening and closing actions are controlled by a control unit (not shown), and adjusts the flow rate of the nitrogen N that is supplied to the heating apparatus 4 in accordance with the control provided by the control unit. The heating apparatus 4 is heat exchanger that heats the nitrogen N supplied from the nitrogen supply apparatus 2 by means of a heat exchange with the air. The blower 5 is an air blower that feeds the nitrogen N that has been heated by the heating apparatus 4 to the vaporizers 6A, 6B, and 6C.

The vaporizers 6A, 6B, and 6C are heat exchangers that vaporize LNG by means of a heat exchange between the nitrogen N that has been heated by the heating apparatus 4 and the LNG supplied from the LNG tank 1. These vaporizers 6A, 6B, and 6C deliver natural gas (NG) obtained from the heat exchange to equipments which demand NG (not shown), and also deliver the nitrogen N after the heat exchange to the recirculation line 7. However, in order to simplify the description, in FIG. 1 a state is shown in which three vaporizers 6A, 6B, and 6C are mounted on the roof of the LNG tank 1, however, the number of vaporizers that may be installed is not limited to this number.

The recirculation line 7 is provided in order to recirculate the nitrogen N after the heat exchange that is discharged from the vaporizers 6A, 6B, and 6C to the heating apparatus 4. More specifically, the recirculation line 7 is provided with a dual system, namely, a first recirculation line 7a that connects a nitrogen discharge port of the vaporizers 6A, 6B, and 6C to the nitrogen intake port of the heating apparatus 4 outside the LNG tank 1 (i.e., above the roof thereof), and a second recirculation line 7b that connects the nitrogen discharge port of the vaporizers 6A, 6B, and 6C to the nitrogen intake port of the heating apparatus 4 via a top portion of the inside of the LNG tank 1 (i.e., immediately below the roof inside the tank).

The cutoff valves 8 and 9 are electromagnetic valves whose opening and closing actions are controlled by a control unit (not shown), and when the temperature of the nitrogen discharge ports of the vaporizers 6A, 6B, and 6C is higher than the temperature of the BOG generated within the LNG tank 1, the cutoff valves 8 and 9 are placed in a closed state via the control of the control unit, so that the flow of nitrogen from the vaporizers 6A, 6B, and 6C to the second recirculation line 7b is shut off. In other words, the cutoff valves 8 and 9 are controlled so as to be in an open state when the temperature of the nitrogen discharge ports of the vaporizers 6A, 6B, and 6C is lower than the temperature of the BOG

The temperature of the BOG is approximately −120° C. Accordingly, when the temperature of the nitrogen discharge ports of the vaporizers 6A, 6B, and 6C is equal to or more than −120° C., the cutoff valves 8 and 9 are controlled so as to be in a closed state, so that the flow of nitrogen discharged from the vaporizers 6A, 6B, and 6C to the second recirculation line 7b is shut off. In this case, the nitrogen N flowing out from the vaporizers 6A, 6B, and 6C is sent to the heating apparatus 4 via the first recirculation line 7a. In contrast, when the temperature of the nitrogen discharge ports of the vaporizers 6A, 6B, and 6C is lower than −120° C., the cutoff valves 8 and 9 are controlled so as to be in an open state, so that the nitrogen N discharged from the vaporizers 6A, 6B, and 6C is delivered to the heating apparatus 4 via the first recirculation line 7a and the second recirculation line 7b.

As described above, according to the LNG vaporization equipment of the first embodiment, when the temperature of the nitrogen discharge ports of the vaporizers 6A, 6B, and 6C (namely, the temperature of the nitrogen N) is lower than −120° C., by allowing the nitrogen N to flow to the second recirculation line 7b, it is possible to suppress the generation of BOG within the LNG tank 1 (i.e., it is possible to use the cooling energy of the LNG to decrease the amount of BOG that is generated).

Moreover, according to the present embodiment, because LNG is vaporized using nitrogen N that can be prepared comparatively easily and at low-cost, there are no restrictions on the location conditions of the LNG vaporization equipment, so that the present embodiment can also be applied to cases in which the LNG tank 1 is located inland where it is not possible for seawater to be used. Furthermore, by mounting the heating apparatus 4, the blower 5, the vaporizers 6A, 6B, and 6C, the recirculation line 7, and the cutoff valves 8 and 9 on the roof of the LNG tank 1, it is possible to decrease installation and construction costs, and achieve a reduction in the installation surface area, and to also more effectively achieve a decrease in the amount of BOG that is generated.

### Second embodiment

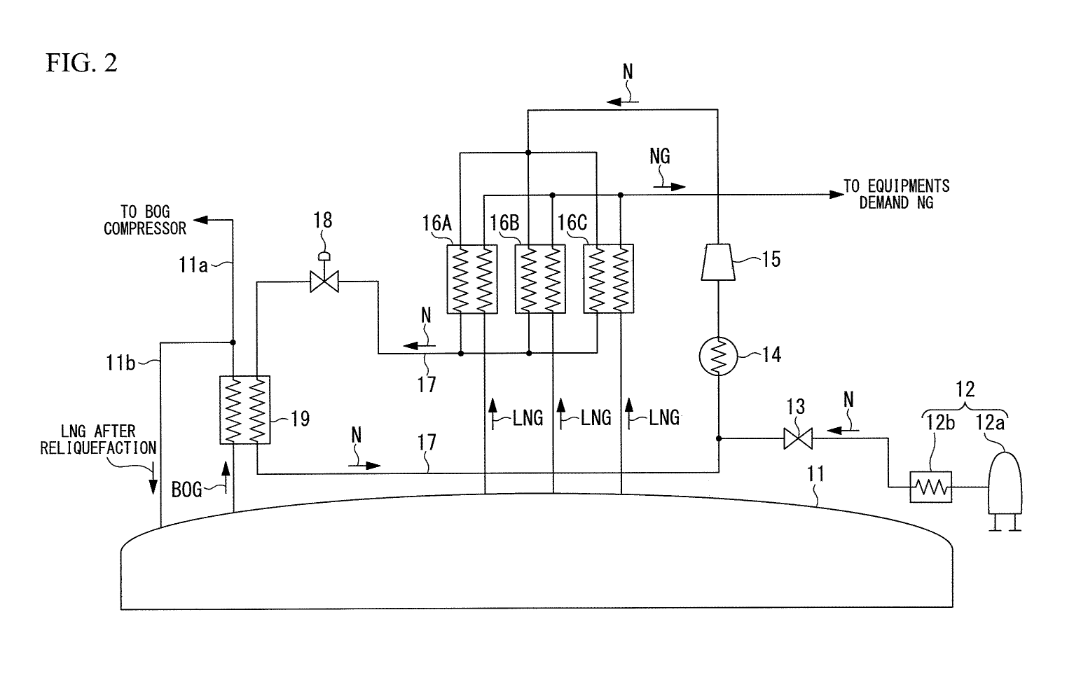

FIG. 2 shows the schematic structure of an LNG vaporization equipment according to a second embodiment. As is shown in FIG. 2, the LNG vaporization equipment according to the second embodiment is formed by an LNG tank 11, a nitrogen supply apparatus 12, a nitrogen flow rate adjuster valve 13, a heating apparatus 14, a compressor 15, vaporizers 16A, 16B and 16C, a recirculation line 17, an expansion valve 18, and a recondensor 19.

Note that, of the aforementioned structural elements, at least the heating apparatus 14, the compressor 15, the vaporizers 16A, 16B, and 16C, the recirculation line 17, the expansion valve 18, and the recondensor 19 are mounted on the roof of the LNG tank 11.

The LNG tank 11 is a stationary tank having a duplex shell structure that is used to store LNG Although omitted from the drawing shown in FIG. 2, a send-out pump that feeds stored LNG to the outside of the tank (i.e., to the vaporizers 16A, 16B, and 16C) is provided inside the LNG tank 11. Moreover, the symbol 11a is a BOG transfer line that discharges BOG that has been generated inside the LNG tank 11 to a BOG compressor (not shown).

The nitrogen supply apparatus 12 is formed by a liquid nitrogen tank 12a in which liquid nitrogen is stockpiled, and a vaporizer 12b that uses a heat exchange with air to vaporize liquid nitrogen that is delivered from the liquid nitrogen tank 12a. The vaporizer 12b delivers gaseous nitrogen (hereinafter, simply referred to as nitrogen) N that it has obtained from the heat exchange with the air to a nitrogen intake port in the heating apparatus 14 via the nitrogen flow rate adjuster valve 13.

The nitrogen flow rate adjuster valve 13 is an electromagnetic valve whose opening and closing actions are controlled by a control unit (not shown), and adjusts the flow rate of the nitrogen N that is supplied to the heating apparatus 14 in accordance with the control provided by the control unit. The heating apparatus 14 is heat exchanger that heats the nitrogen N supplied from the nitrogen supply apparatus 12 by means of a heat exchange with the air. The compressor 15 compresses the nitrogen N that has been heated by the heating apparatus 14, and then feeds it to the vaporizers 16A, 16B, and 16C.

The vaporizers 16A, 16B, and 16C are heat exchangers that vaporize LNG by means of a heat exchange between the nitrogen N that has been heated by the heating apparatus 14 and the LNG supplied from the LNG tank 11. These vaporizers 16A, 16B, and 16C deliver natural gas (NG) obtained from the heat exchange to equipments which demand NG (not shown), and also deliver the nitrogen N after the heat exchange to the recirculation line 17. Note that, in order to simplify the description, in FIG. 2, a state is shown in which three vaporizers 16A, 16B, and 16C are mounted on the roof of the LNG tank 11, however, the number of vaporizers that may be installed is not limited to this number.

The recirculation line 17 is provided in order to recirculate the nitrogen N after the heat exchange that is discharged from the vaporizers 16A, 16B, and 16C to the heating apparatus 14, and connects a nitrogen discharge port of the vaporizers 16A, 16B, and 16C to the nitrogen intake port of the heating apparatus 14 outside the LNG tank 11 (i.e., above the roof thereof). The expansion valve 18 and the recondensor 19 are installed along the recirculation line 17.

The expansion valve 18 functions as a first temperature adjustor that expands the nitrogen N flowing through the recirculation line 17 and adjusts the temperature of the nitrogen N to a temperature that enables the BOG generated within the LNG tank 11 to be reliquefied. The recondensor 19 is a heat exchanger that reliquefies BOG using a heat exchange between the temperature-adjusted nitrogen N and the BOG that has been discharged from the LNG tank 11 via the BOG transfer line 11a. The recondensor 19 returns the BOG after reliquefaction (namely, the LNG) to an inside of the LNG tank 11 via a BOG return line 11b, and delivers the nitrogen N after the heat exchange to the heating apparatus 14 via the recirculation line 17.

Here, both of the BOG transfer lines 11a and 11b are connected to the top of the roof of the LNG tank 11, and the recondensor 19 is provided independently immediately adjacent to the roof of the LNG tank 11. A pressurizing equipment or the like is not especially provided on the BOG transfer line 11a between the LNG tank 11 and the recondensor 19. Namely, while the operating pressure of the LNG tank 11 is held at a constant level, the BOG discharged from the LNG tank 11 undergoes a heat exchange in the recondensor 19 with the nitrogen that has already undergone a heat exchange and has been discharged from the vaporizers 16A, 16B, and 16C, and is liquefied.

As described above, according to the LNG vaporization equipment of the second embodiment, using the nitrogen after the heat exchange with the LNG as a medium, the cooling energy of LNG can be used to reliquefy BOG. Moreover, because the recondensor 19 is provided independently at a distance from the vaporizers 16A, 16B, and 16C, the heat exchange temperature in the recondensor 19 can be set to a temperature that enables the BOG to be reliquefied easily, using the expansion valve 18 where necessary, without it being affected by (the warming action of) the vaporizers 16A, 16B, and 16C and the like. As a result of this, even if a pressurizing equipment for liquefying heated BOG is not provided on the BOG transfer line 11a between the LNG tank 11 and the recondensor 19, then while the operating pressure of the LNG tank 11 is held at a constant level, namely, is held at a relatively low temperature, the BOG discharged from the LNG tank 11 is able to undergo a heat exchange with the nitrogen that has already undergone a heat exchange and has been discharged from the vaporizers. Moreover, because a pressurizing equipment or the like is not provided on the BOG transfer line 11a, the costs associated with the installation of such a pressurizing equipment are not incurred.

Moreover, the BOG is discharged into the BOG transfer line 11a above the roof of the LNG tank 11, and passes through the recondensor 19 and the BOG transfer line 11b, and, with the operating pressure of the LNG tank 11 being kept at a constant level, is recovered from above the roof of the LNG tank 11 as reliquefied LNG into the inside of the LNG tank 11. Because of this, the amount of heat required when the reliquefied LNG is being recovered can be kept to a minimum, and reliquefied LNG can be recovered safely.

Moreover, according to the present embodiment, in the same way as in the first embodiment, because the LNG can be vaporized using the nitrogen N, which can be prepared comparatively easily and at low-cost, there are no restrictions on the location conditions of the LNG vaporization equipment, so that the present embodiment can also be applied to cases in which the LNG tank 11 is located inland from the coast where it is not possible for seawater to be used. Furthermore, by mounting the heating apparatus 14, the compressor 15, the vaporizers 16A, 16B, and 16C, the recirculation line 17, the expansion valve 18, and the recondensor 19 on the roof of the LNG tank 11, it is possible to reduce installation and construction costs, and achieve a reduction in the installation surface area, and to also more effectively achieve a decrease in the amount of BOG that is generated.

### Third embodiment

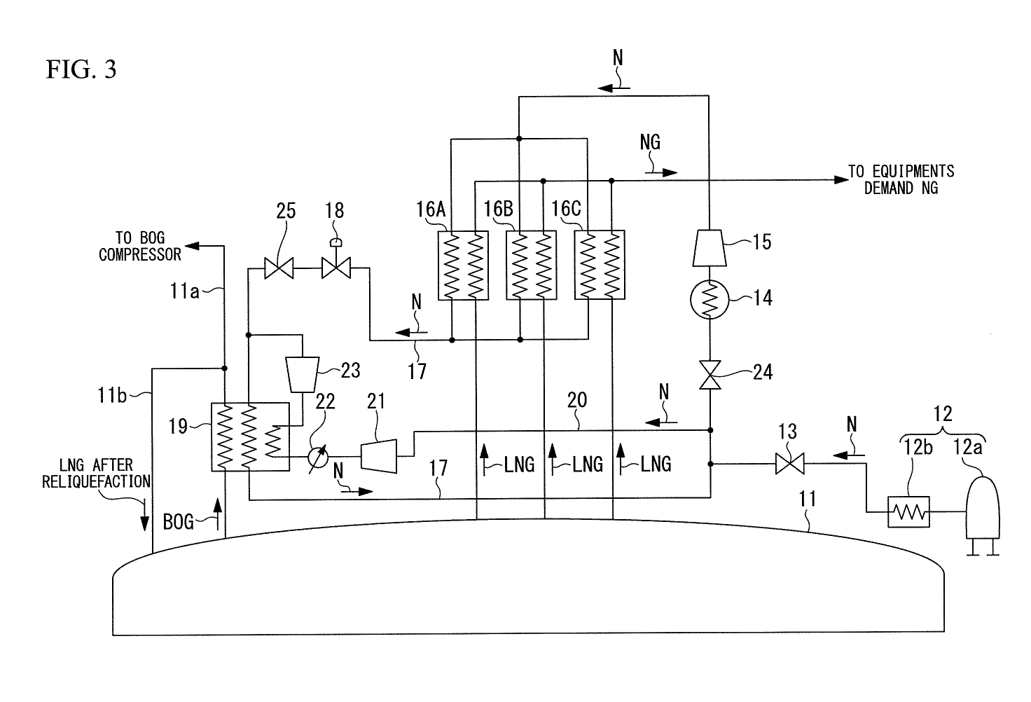

FIG. 3 shows the schematic structure of an LNG vaporization equipment according to a third embodiment. Note that the LNG vaporization equipment according to the third embodiment is a modified version of the LNG vaporization equipment according to the second embodiment. Because of this, hereinafter, only those portions of the LNG vaporization equipment of the third embodiment that are different from the LNG vaporization equipment of the second embodiment will be examined and described, and portions that are the same as those in the second embodiment are given the same descriptive symbols and are not described.

As is shown in FIG. 3, the LNG vaporization equipment according to the third embodiment is formed by additionally providing a nitrogen supply line 20, a compressor 21, an after cooler 22, an expander 23, a first cutoff valve 24, and a second cutoff valve 25 in the LNG vaporization equipment according to the second embodiment.

The nitrogen supply line 20 is a bypass line that connects the nitrogen intake port of the heating apparatus 14 to the nitrogen intake port of the recondensor 19. The compressor 21, the after cooler 22, and the expander 23 are installed along this nitrogen supply line 20. The compressor 21 compresses the nitrogen N flowing through the nitrogen supply line 20, and delivers it to the after cooler 22. The after cooler 22 pre-cools the nitrogen N delivered under pressure from the compressor 21, and then delivers it to the expander 23. The expander 23 expands the nitrogen N that has been pre-cooled by the after cooler 22, and functions as a second temperature adjuster that adjusts the temperature of the nitrogen N to a temperature that enables the BOG to be reliquefied.

The first cutoff valve 24 is an electromagnetic valve whose opening and closing actions are controlled by a control unit (not shown), and when no LNG is fed from the LNG tank 11 in accordance with the control being performed by the control unit, the first cutoff valve 24 is placed in a closed state in which the nitrogen N is supplied to the recondensor 19 via the nitrogen supply line 20 so that the flow of nitrogen to the heating apparatus 14 is blocked. In other words, the first cutoff valve 24 is controlled so as to be in an open state when LNG is being fed from the LNG tank 11.

The second cutoff valve 25 is an electromagnetic valve whose opening and closing actions are controlled by a control unit (not shown), and when no LNG is fed from the LNG tank 11 in accordance with the control being performed by the control unit, the second cutoff valve 25 is placed in a closed state in which the nitrogen N is supplied to the recondensor 19 via the nitrogen supply line 20 so that the reverse flow of nitrogen from the recondensor 19 to the vaporizers 16A, 16B, and 16C is blocked. In other words, the second cutoff valve 25 is controlled so as to be in an open state when LNG is being fed from the LNG tank 11.

Namely, in the LNG vaporization equipment according to the third embodiment, when LNG is fed out from the LNG tank 11, in the same way as in the second embodiment, the nitrogen N used to vaporize the LNG is reused to reliquefy the BOG In contrast, when LNG is not being fed out from the LNG tank 11, the nitrogen N supplied via the nitrogen supply line 20 is used to reliquefy the BOG, so that the BOG can be continuously reliquefied even when no LNG is being supplied. In this case, the remainder of the operation and effects of the third embodiment are the same as those of the second embodiment.

A first embodiment through a third embodiment of the present invention have been described above, however, the present invention is not limited to these embodiments and various modifications to these embodiments may be made insofar as they do not depart from the scope of the present invention. For example, the following variant examples of the present invention may be used in addition to the above-described embodiments.

[1] In the above-described embodiments, a structure in which various types of machinery are installed on the roof of the LNG tank 1 (11) is described as an example, however, the present invention is not limited to this and a structure in which the machinery is installed on a side wall of the LNG tank 1 (11), or a structure in which they are installed at a different location from the LNG tank 1 (11) may also be employed.
(2) In the above-described embodiment, a case is described in which the nitrogen supply apparatus 2 (12) is formed by the liquid nitrogen tank 2a (12a) and the vaporizer 2b (12b), however, the present invention is not limited to this and it is also possible to use a PSA (Pressure Swing Adsorption) type of nitrogen gas generating apparatus as the nitrogen supply apparatus. As it is known, a PSA system is one that generates extremely pure nitrogen gas by using an adsorbent to split oxygen and nitrogen in the atmosphere.

### Industrial applicability

According to the present invention, it is possible to provide an LNG vaporization equipment that is able to use the cooling energy of LNG to reduce the quantity of BOG that is generated, or for reliquefaction.

### DESCRIPTION OF THE REFERENCE NUMERALS

1, 11 . . . LNG tank

2, 12 . . . Nitrogen supply apparatus

4, 14 . . . Heating apparatus

6A, 6B, 6C, 16A, 16B, 16C . . . Vaporizer

7, 17 . . . Recirculation line

1. An LNG vaporization equipment comprising:
a nitrogen supply apparatus;
a heating apparatus that heats nitrogen supplied from the nitrogen supply apparatus;
vaporizers that vaporize LNG by means of a heat exchange between the nitrogen heated by the heating apparatus and the LNG that is fed out from an LNG tank; and
a recirculation line that, after the nitrogen after the heat exchange that has been discharged from the vaporizers has been used to reduce the amount of BOG that is generated or has been used for reliquefaction, recirculates it to the heating apparatus.

2. The LNG vaporization equipment according to claim 1, wherein,
when the nitrogen after the heat exchange that is discharged from the vaporizers is used to reduce the amount of BOG that is generated,
the recirculation line is installed as a dual system that is formed by a first recirculation line that connects a nitrogen discharge port of the vaporizers to a nitrogen intake port of the heating apparatus outside the LNG tank, and a second recirculation line that connects the nitrogen discharge port of the vaporizers to the nitrogen intake port of the heating apparatus via an inside of the LNG tank.

3. The LNG vaporization equipment according to claim 2, wherein there is provided a cutoff valve that, when the temperature of the nitrogen discharge port of the vaporizers is equal to or higher than the temperature of the BOG that is generated inside the LNG tank, blocks the inflow of nitrogen from the vaporizers to the second recirculation line.

4. The LNG vaporization equipment according to claim 1, wherein,
when the nitrogen after the heat exchange that is discharged from the vaporizers is used to reliquefy the BOG,
the recirculation line is installed so as to connect the nitrogen discharge port of the vaporizers to the nitrogen intake port of the heating apparatus outside the LNG tank, and
along the recirculation line there are provided:
a first temperature adjuster that adjusts the temperature of the nitrogen flowing through the recirculation line to a temperature that enables the BOG generated within the LNG tank to be reliquefied; and
a recondensor that reliquefies the BOG using a heat exchange between the temperature-adjusted nitrogen and the BOG that has been discharged from the LNG tank, and then restores the reliquefied BOG to an inside of the LNG tank.

5. The LNG vaporization equipment according to claim 4, wherein there are provided:
a nitrogen supply line that connects the nitrogen intake portion of the heating apparatus to the nitrogen intake port of the recondensor;
a second temperature adjuster that is installed along the nitrogen supply line, and adjusts the temperature of the nitrogen flowing through the nitrogen supply line to a temperature that enables the BOG generated within the LNG tank to be reliquefied; and
a first cutoff valve that blocks an inflow of nitrogen to the heating apparatus, and a second cutoff valve that blocks a reverse flow of nitrogen from the recondensor to the vaporizers such that, when the LNG is not being fed out from the LNG tank, nitrogen is supplied to the recondensor via the nitrogen supply line.

6. The LNG vaporization equipment according to claim 4, wherein, while the operating pressure of the LNG tank is held at a constant level, the BOG discharged from the LNG tank undergoes a heat exchange with nitrogen that has already undergone a heat exchange and has been discharged from the vaporizers.

7. The LNG vaporization equipment according to claim 5, wherein, while the operating pressure of the LNG tank is held at a constant level, the BOG discharged from the LNG tank undergoes a heat exchange with nitrogen that has already undergone a heat exchange and has been discharged from the vaporizers.

8. The LNG vaporization equipment according to claim 1, wherein the heating apparatus, the vaporizers, and the recirculation line are installed on the roof of the LNG tank.
